(19) United States
(12) Patent Application Publication
(10) Pub. No.: US 2024/0429490 A1
(43) Pub. Date: Dec. 26, 2024

(54) SYSTEM AND METHOD FOR INTERNAL BATTERY HEATING THROUGH HIGH FREQUENCY AND HIGH AMPERAGE SHORT CIRCUIT CURRENT

(71) Applicant: Hybrid Power Solutions, Etobicoke (CA)

(72) Inventor: Francois Renaud-Byrne, Etobicoke (CA)

(21) Appl. No.: 18/751,018

(22) Filed: Jun. 21, 2024

Related U.S. Application Data
(60) Provisional application No. 63/509,289, filed on Jun. 21, 2023.

(51) Int. Cl. H01M 10/6571; H01M 10/42; H01M 10/48; H01M 10/615; H01M 10/633; H01M 10/655

(52) U.S. Cl. CPC H01M 10/6571; H01M 10/425; H01M 10/486; H01M 10/615; H01M 10/633; H01M 10/655; H01M 2010/4271

(57) ABSTRACT

A system for internal heating of a battery, including: the battery; and a control system, including: a microcontroller unit; a current sensor; a temperature sensor; and a MOSFET switch; wherein: the current sensor measures a SC current applied to the battery; the temperature sensor measures an internal temperature of the battery; the MCU is configured to monitor the SC current applied to the battery and the internal temperature of the battery; the MCU is configured to activate internal heating of the battery when the internal temperature of the battery is less than a temperature setpoint; and the MCU is configured to generate a PWM signal to switch the MOSFET switch on and off when the internal heating of the battery is activated.

### FIELD OF THE DISCLOSURE

The disclosure generally relates to battery systems, and more particularly, to battery heating systems and methods.

### BACKGROUND

The use of batteries in sub-zero temperatures is a significant challenge in many modern applications. At temperatures below 0 degrees Celsius, batteries experience a substantial decline in performance, affecting key parameters such as state of charge (SOC) and capacity. Moreover, charging batteries in these conditions can lead to adverse chemical reactions within the cells, resulting in reduced lifespan and long-term efficiency. To prevent these issues, it is crucial to preheat batteries to temperatures above freezing before charging.

Traditional battery heating systems and methods typically involve external techniques such as heat blankets and external heaters. While these systems and methods can raise the battery temperature, they are often inefficient and require considerable time to achieve the desired results. This inefficiency can be problematic in applications where time and energy conservation are critical. To address these limitations, improved battery heating systems and methods are needed.

### SUMMARY

The following presents a simplified summary of some embodiments of the techniques described herein in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

Embodiments provide a system for internal heating of at least one battery, including: the at least one battery; and a control system, including: a microcontroller unit; at least one current sensor; at least one temperature sensor; and at least one metal-oxide-semiconductor field-effect transistor (MOSFET) switch; wherein: the at least one current sensor measures a short circuit (SC) current applied to the at least one battery; the at least one temperature sensor measures an internal temperature of the at least one battery; the MCU is configured to monitor the SC current applied to the at least one battery and the internal temperature of the at least one battery; the MCU is configured to activate internal heating of the at least one battery when the internal temperature of the at least one battery is less than a temperature setpoint, wherein the SC current applied to the at least one battery is less than a SC current setpoint; and the MCU is configured to generate a pulse width modulation (PWM) signal to switch the at least one MOSFET switch on and off when the internal heating of the at least one battery is activated.

Embodiments include a method for internal heating of at least one battery, including: measuring, with at least one current sensor, a short circuit (SC) current applied to at least one battery; measuring, with at least one temperature sensor, an internal temperature of the at least one battery; monitoring, with an MCU, the SC current applied to the at least one battery and the internal temperature of the at least one battery; activating, with the MCU, internal heating of the at least one battery when the internal temperature of the at least one battery is less than a temperature setpoint, wherein the SC current applied to the at least one battery is less than a SC current setpoint; and generating, with the MCU, a pulse width modulation (PWM) signal to switch the at least one MOSFET switch on and off when the internal heating of the at least one battery is activated.

### BRIEF DESCRIPTION OF THE FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1A illustrates an example of a control system and battery for internal heating of the battery, according to some embodiments.

FIG. 1B illustrates an example of an electrical circuit of the control system and the battery illustrated in FIG. 1A, according to some embodiments.

FIG. 2 illustrates an example of pulse width modulation (PWM) variable duty cycle logic loop, according to some embodiments.

FIG. 3 illustrates a flowchart of an internal heating of a battery, according to some embodiments.

### DETAILED DESCRIPTION OF SOME EMBODIMENTS

The present inventions will now be described in detail with reference to a few embodiments thereof as illustrated in the accompanying drawings. In the following description, numerous specific details are set forth in order to provide a thorough understanding of the present inventions. It will be apparent, however, to one skilled in the art, that the present invention may be practiced without some or all of these specific details. In other instances, well known process steps and/or structures have not been described in detail in order to not unnecessarily obscure the present invention. Further, it should be emphasized that several inventive techniques are described, and embodiments are not limited to systems implanting all of those techniques, as various cost and engineering trade-offs may warrant systems that only afford a subset of the benefits described herein or that will be apparent to one of ordinary skill in the art.

Aspects of the invention include a system for internal heating of batteries including at least a control system and a battery. Various types of rechargeable batteries with different chemistries, such as LiFePO4 batteries, may be internally heated using the control system. The control system creates a short circuit (SC) current at high frequency, causing the generation of heat energy from internal resistance of a battery. The control system includes at least a microcontroller unit (MCU) including a printed circuit board including a processor and a memory, at least one current sensor, at least one temperature sensor, and a plurality of metal-oxide-semiconductor field-effect transistor (MOSFETs) switches. A current sensor measures the SC current being applied to the battery to generate internal heat. The MCU detects when the SC current is over a maximum current setpoint based on the measured SC current for battery safety. A temperature sensor measures an internal temperature of the battery, providing feedback for the control system as to when the battery requires heating or has reached a required temperature setpoint. The MOSFET switches switch on/off at a high frequency to control the flow of the SC current through an anode, a cathode, and an electrolyte to ensure the SC current stays within a specified safe range. Two parameters critical in the selection of a MOSFET switch are a maximum frequency at which the MOSFET switch can switch on/off and ability to dissipate heat. The MCU generates a PWM signal that controls the MOSFET switching on/off, and in turn, controls the SC current at frequencies up to 100 KHz. In some embodiments, the MCU communicates with a user interface of the system for internal heating of batteries or a mobile application of a computing device configured to display data such as SC current and temperature values of the battery and receive user input designating an instruction to turn the control system on/off.

Determining the correct SC current to apply is critical for internally heating batteries, as a low SC current takes too long to heat the battery and a SC current that breaches a maximum threshold may cause critical damage to the battery. As batteries scale in size, voltage, and amperage, battery-specific testing is required to determine an optimal SC current to be applied for internal heating of the battery. A useful unit for testing and specifying a battery SC current is the C-rate, a measure of how fast a battery can charge and discharge its current. For example, a C-rate of 1C indicates a battery that may be fully charged or discharged within one hour. For example, based on LiFePO4 battery testing performed on two cells connected in a series configuration creating 6.6V and 125 Ah, optimal C-rates are in a range of 0.5C to 2C. For a battery with capacity of 100-125 Ah, the optimal C-rate is 1C, corresponding to SC current of 100A-125A. The control system may be used to internally heat different battery chemistries, each different type of battery having different voltage and amperage levels and optimal C-rate. In some embodiments, the MCU autonomously learns (e.g., using machine learning techniques) the optimal C-rate (within a range that is not damaging to the battery and its lifespan) based on measurable performance metrics (e.g., a rate at which the internal temperature of the battery rises) associated with different battery chemistries and external variables (e.g., ambient temperature).

Testing for optimal PWM frequency and PWM duty cycle is also important for the safety and internal heating time of the battery. The PWM frequency and the PWM duty cycle control the SC current increment rate and the stability of the SC current once it reaches a setpoint SC current value. Given the optimal PWM duty cycle varies with different PWM frequencies, the battery must be tested to determine the optimal PWM duty cycle for different PWM frequencies. For example, based on LiFePO4 battery testing performed, optimal PWM frequencies are in the range of 10-100 KHz and at 50 kHz the optimal PWM duty cycles are in the range of 51-54%. For two cells that are connected in series, the optimal PWM frequency is 50 kHz as it provides better control and current response while preventing damage to hardware. At this PWM frequency, the MOSFET switches switch every 20 us. The control system may be used to internally heat different battery chemistries, each different type of battery having different optimal PWM frequency and PWM duty cycle. In some embodiments, the MCU autonomously learns (e.g., using machine learning techniques) the optimal PWM frequency (within a range that is not damaging to the battery and its lifespan) based on measurable performance metrics (e.g., a rate at which the internal temperature of the battery rises with variable C-rate and SC) associated with different battery chemistries and external variables (e.g., ambient temperature).

In some embodiments, control system logic is dictated primarily by two parameters, the SC current measured by the current sensor and the internal battery temperature measured by the temperature sensor. The MCU activates internal heating of the battery when the SC current is lower than the factory SC current setpoint and the internal battery temperature is lower than the factory temperature setpoint. The MCU monitors the SC current and the internal battery temperature measured, and when the required conditions are met, activates the internal battery heating process. The factory temperature setpoint is typically set to 0 degrees Celsius and the internal battery heating process is activated when the internal battery temperature is between −30 to −20 degrees Celsius. The internal battery temperature of 0 degrees Celsius is the ideal minimum temperature for charging/discharging a battery without potentially causing damage. The factory SC current setpoint is typically 1C. The MCU monitors the SC current based on the current measured by the current sensor to ensure the internal battery heating process is deactivated when a high limit SC current is reached (e.g., 10A over the 1C SC current). If the high limit SC current is reached, the MCU actuates the MOSFET switches to open, stopping the SC current from flowing through the battery and/or reduces the PWM duty cycle until the SC current returns to a safe point.

In some embodiments, the MCU of the control system determines the SC current required to achieve a voltage drop near zero volts based on the battery SOC. The heat generated in the battery from a SC current is significantly higher when a voltage drop across battery terminals approaches zero volts. When a battery has a healthy SOC (e.g., >80%), a SC current with a C-rate substantial enough (e.g., 1C) to make the voltage drop to zero volts across the terminals results in the fastest heating. If the battery has reduced capacity or a low SOC (e.g., <50%), a reduced C-rate (e.g., 0.25-0.75C) is required to achieve a voltage drop of zero volts across the battery terminals. Based on this logic, the MCU adjusts the SC current and C-rate based on the SOC of the battery. However, it is noted that using SC current for heating at low battery SOC can affect the health of the battery as the battery is more vulnerable to damage at low SOC. A reduced SOC may be present at the time of initiation of or during the internal heating of the battery. For example, a user may turn on the system for internal heating of the battery and the battery SOC may already be 40%. Or, a user may turn on the system for internal heating of the battery and the SOC may be at 70% and after 10 minutes of internal heating the SOC may drop to 40%.

In some embodiments, internal resistance of the battery sharply increases with temperature drop for some battery chemistries (e.g., lithium ion). This has a significant effect on the SC current drawn and heat generated by the SC current. At low temperatures and high internal resistance, the SC current is low and easy to control. As battery temperature increases, the internal resistance decreases, and therefore, the SC current requires more control and management by the control system. Other battery chemistries (e.g., LiFePO4) exhibit an internal resistance that is less effected by a drop in temperature, and therefore, have SC currents and heating characteristics, where the SC current requires more control from the start of internal heating of the battery.

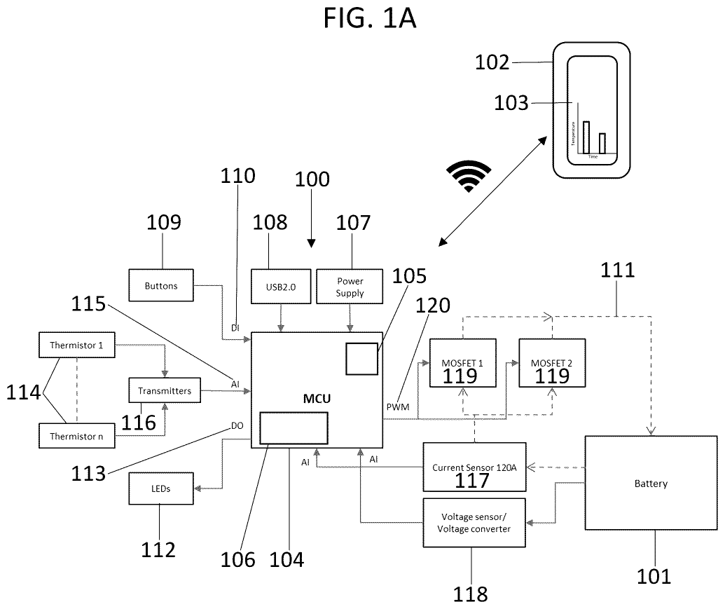

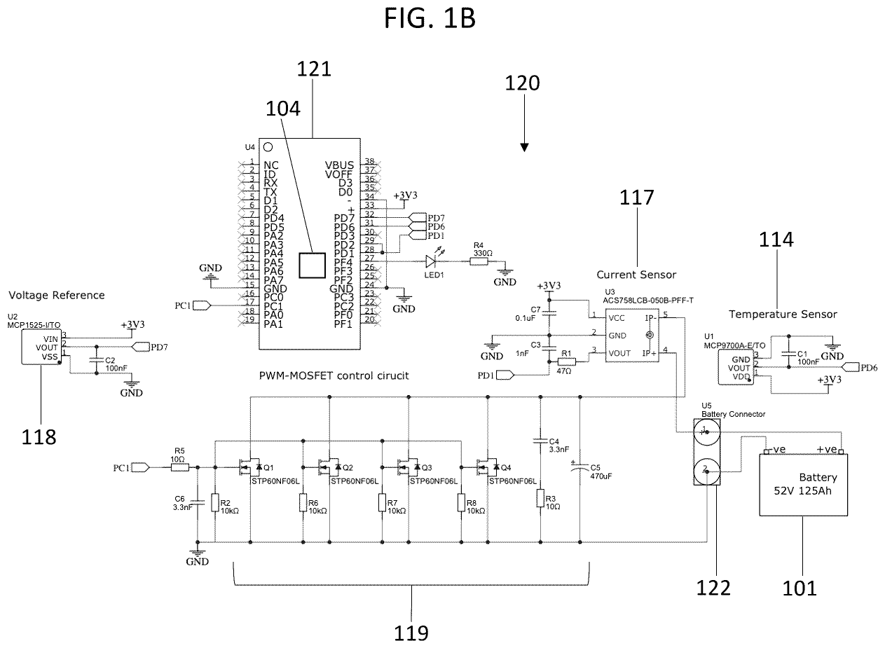

FIG. 1A illustrates an example of a system for internal heating of batteries including a control system 100, a battery 101, and a computing device 102 executing a mobile application 103 communicatively coupled to the control system 100. The control system 100 includes an MCU 104 including a processor 105 and a memory 106, the MCU 104 powered by a 5V direct current source 107 or USB via a USB 2.0 plug 108. The control system 100 further includes buttons 109 installed on a PCB 121 connected to digital inputs 110 of the MCU 104 for starting/stopping the SC current 111, LEDs 112 connected to digital outputs 113 of the MCU 104 for indicating on, off, and idle states, thermistors 114 connected to analog input pins 115 of the MCU 104 through transmitters 116 and attached to a surface of the battery 101 for providing temperature data of the battery 101, a current sensor 117 connected to the analog input 115 of the MCU 104, a voltage sensor 118 connected to the analog input 115 of the MCU 104, and two MOSFET switches 119 connected to a PWM programmed pin 120 of the MCU 104. The MOSFET switches 119 are opened and closed to control the SC current 111 according to a variable PWM duty cycle determined by the MCU 104 based on an analysis of data captured by the current sensor 117, the temperature sensor 114, and the voltage sensor 118. The dashed lines in FIG. 1A illustrate current flow when the internal heating of the battery 101 is occurring.

FIG. 1B illustrates an example of an electrical circuit 120 of the control system 100 and the battery 101 illustrated in FIG. 1A including a PCB 121, the MCU 104, the temperature sensor 114, the current sensor 117, the voltage sensor 118, the MOSFET switches 119, and a battery connector 122.

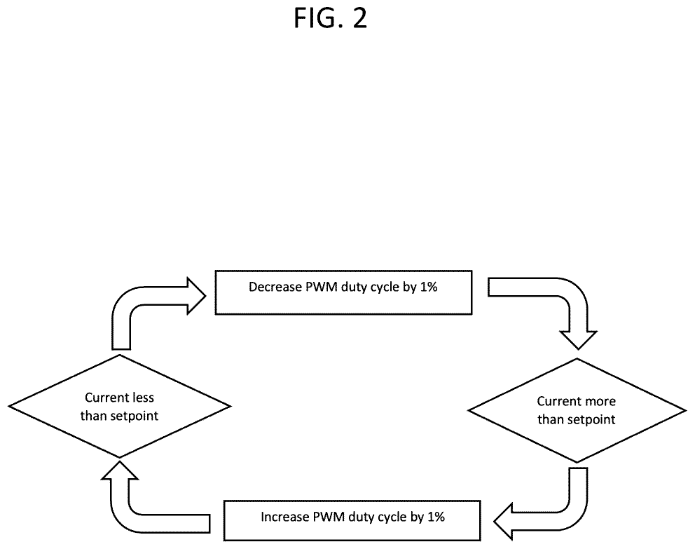

The control system further includes two unique logic functions to enable the MOSFET switches to handle potentially high amperage SC currents at a C-rate of 1C and to protect the battery and components of the control system with a stable SC current. When the internal battery heating process is activated, the MCU also activates an on/off timer and the on timer begins to count. For a two cell battery system in series configuration with a 1C SC, a 50 KHz PWM signal with a 52% duty cycle is also initiated at start-up. The PWM frequency and the PWM duty cycle may vary depending on the battery specifications. The PWM duty cycle is treated as a variable that the MCU increases or decreases according to the current sensor output, while the ON timer counts. If the current measured has a C-rate more or less than the C-rate setpoint (e.g., 1C), the MCU increases or decreases the duty cycle by 1%, respectively, allowing the MOSFET switches to open or close to control and stabilize the SC current within a range close to the C-rate setpoint. This variable PWM duty cycle loop continues throughout the on timer factory setpoint period (e.g., 15 seconds for a 1C SC). Once the on timer times out, the variable PWM duty cycle loop is terminated, the off timer starts to count, and the MOSFET switches transfer their excess heat to the battery, preventing overheating and damage to the MOSFET switches. Upon completion of the off timer factory setpoint period (e.g., 30 seconds), the MCU actuates the MOSFET switches to close, SC current flows through the battery once again, and the PWM duty cycle loop begins again until the factory internal battery temperature setpoint is reached. Additional safety logic is also created within the variable PWM duty cycle loop, wherein the MCU may change the duty cycle by values larger than 1% if the SC current reaches a high current setpoint limit. FIG. 2 illustrates an example of the PWM variable duty cycle logic loop.

In some embodiments, the PWM duty cycle logic for controlling the opening and the closing of the MOSFET switches is opposite to that described above, as it is dependent on the specific hardware (e.g., MCU or PLC) used in the control system. For example, an MCU manufactured by supplier A may require an increase in the duty cycle by 1% to cause the MOSFET switches to be open longer while an MCU manufactured by supplier B may require an increase in the duty cycle by 1% to cause the MOSFET switches to stay closed for longer.

Some embodiments provide a user with an option to switch between an automatic and a manual mode for activation/deactivation of the internal battery heating process. The MCU may be configured to receive user input designating an instruction to operate in the automatic mode or the manual mode. The user input may be received from the user interface of the system for internal heating of batteries or the mobile application of the computing device. In the automatic mode, the internal battery temperature is continuously monitored and the internal battery heating process is autonomously activated when the temperature is below a minimum setpoint and deactivated when the minimum temperature setpoint is reached. The automatic mode may be ideal when the battery is used on a daily basis within low temperature environments, while the manual mode may be ideal for occasional use of the battery or when the battery is infrequently operated within cold environments.

Some embodiments provide the user with an option to control the internal battery heating time. The user interface may be configured to receive user input designating an instruction to adjust the SC current. In such a case, the hardware must be capable of handling the highest SC current allowable. The on/off timer and PWM duty cycle logic must also be altered to accommodate different SC currents.

Some embodiments incorporate a heat spreader to transfer heat generated by the MOSFET switches to internal battery cells, rather than using heat sinks with fans. A heat spreader spreads the heat across its entire surface and potentially provides a more efficient means of dissipating heat. Temperature sensors must be carefully placed when using a heat spreader to ensure accurate readings from the internal battery cells and avoid erroneous readings from the surface of the heat spreader.

Some embodiments provide the user with wireless access to the control system via Bluetooth or radio frequency. Wireless access is also possible through Wi-Fi connectivity or via telecom services using modules that facilitate long term evolution connections. The mobile (or web) application executed on the computing device (e.g., smartphone, laptop, tablet, etc.) may be used to review data relating to the battery and to receive user input designating instructions to activate and deactivate the internal battery heating process, a current drawn or C-rate, a PWM frequency, and a time to heat (e.g., 15 minutes, 30 minutes). In some embodiments, the MCU or the mobile application determines the current drawn or C-rate and the PWM frequency based on the user input designating the time to heat. In some embodiments, the MCU or the mobile application autonomously learns (e.g., using artificial intelligence machine learning techniques) the optimal C-rate and the optimal PWM frequency (within a range that is not damaging to the battery and its lifespan) based on measurable performance metrics (e.g., a rate at which the internal temperature of the battery rises).

In some embodiments, the MCU is communicatively coupled with the mobile application of the computing device and/or the user interface of the control system. In some embodiments, the memory of the MCU includes a media storing instructions that when executed by the processor effectuates operations (e.g., instructions designated by the at least one input received by the mobile application or the user interface or program code stored on the media). In some embodiments, the MCU determines and actuates implementation of optimal settings (e.g., C-rate, PWM frequency, etc.) for internal heating of the battery based on historical settings used and the performance metrics achieved and/or historical weather and the performance metrics achieved. In some embodiments, the MCU uses machine learning to determine the most optimal settings for internal heating of the battery.

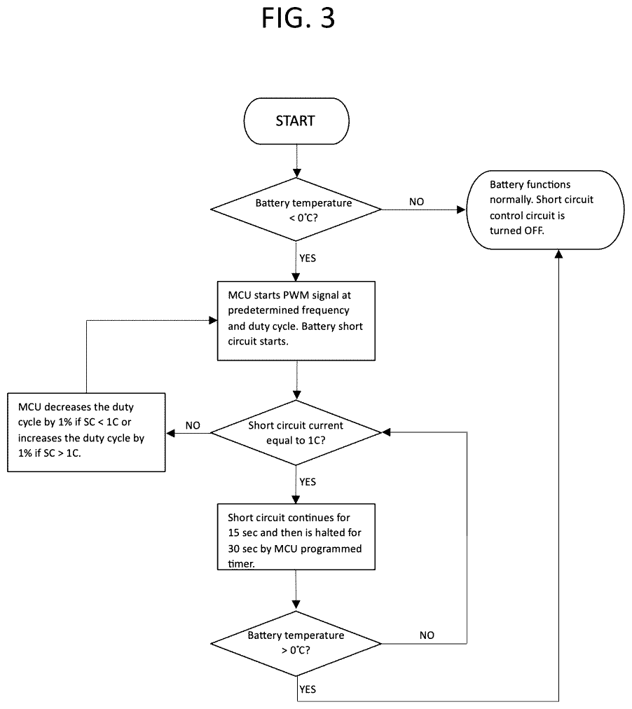

FIG. 3 illustrates a flowchart of an example of a process for internal heating of a battery.

In some embodiments, SC heating of the battery may be paired with other methods for heating the battery, such as external heat blankets. In some embodiments, the heat generated for heating the battery emanates from the battery and is used for heating adjacent objects or items (e.g., an adjacent fluid, etc.).

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device and can interface with circuitry to perform the described tasks.

The above-described embodiments are intended to be examples only. Alterations, modifications and variations can be affected to the particular embodiments by those of skill in the art without departing from the scope, which is defined solely by the claims appended hereto.

1. A system for internal heating of at least one battery, comprising:
the at least one battery; and
a control system, comprising:
a microcontroller unit;
at least one current sensor;
at least one temperature sensor; and
at least one metal-oxide-semiconductor field-effect transistor (MOSFET) switch;
wherein:
the at least one current sensor measures a short circuit (SC) current applied to the at least one battery;
the at least one temperature sensor measures an internal temperature of the at least one battery;
the MCU is configured to monitor the SC current applied to the at least one battery and the internal temperature of the at least one battery;
the MCU is configured to activate internal heating of the at least one battery when the internal temperature of the at least one battery is less than a temperature setpoint, wherein the SC current applied to the at least one battery is less than a SC current setpoint; and
the MCU is configured to generate a pulse width modulation (PWM) signal to switch the at least one MOSFET switch on and off when the internal heating of the at least one battery is activated.

2. The system of claim 1, wherein the MCU is further configured to, iteratively:
activate an on timer of an on/off timer when the internal heating of the at least one battery is activated;
execute a variable PWM duty cycle loop until a time measured by the on timer reaches an on timer setpoint period, wherein the MCU increases or decreases a PWM duty cycle based on the SC current applied to the at least one battery;
terminate the variable PWM duty cycle loop and activate an off timer of the on/off timer upon reaching the on timer setpoint period, wherein excess heat generated by the at least one MOSFET switch is transferred to the at least one battery; and
generating the PWM signal to switch the at least one MOSFET switch on upon a time measured by the off timer reaching an off timer setpoint period.

3. The system of claim 2, wherein the MCU increases or decreases the PWM duty cycle by a percentage value when the SC current applied to the at least one battery has a C-rate greater or less than a C-rate setpoint or the SC current applied to the at least one battery is greater or less than the SC current setpoint.

4. The system of claim 3, wherein:
the percentage value is one percent; and
the percentage value is adjusted to a magnitude greater than the one percent when the SC current applied to the at least one battery reaches a threshold SC current.

5. The system of claim 2, further comprising a heat spreader for transferring the excess heat generated by the at least one MOSFET switch to the at least one battery.

6. The system of claim 1, wherein:
the temperature setpoint is 0 degrees Celsius and
the SC current setpoint is 100 Amps.

7. The system of claim 1, wherein the PWM signal generated switches the at least one MOSFET switch on and off at a frequency up to 100 KHz.

8. The system of claim 1, wherein:
the MCU or a mobile application executed on a computing device communicatively coupled with the MCU is configured to autonomously learn an optimal C-rate and an optimal PWM frequency, within a range that is not damaging to the at least one battery and its lifespan, for different battery chemistries, battery state of charges, battery capacities, and ambient temperatures based on performance metrics using machine learning techniques; and
the performance metrics comprise at least a rate at which the internal temperature of the at least one battery rises.

9. The system of claim 1, wherein the MCU or a mobile application executed on a computing device communicatively coupled with the MCU is configured to determine a C-rate and a PWM frequency based on user input designating an amount of time to heat the at least one battery.

10. The system of claim 1, wherein a user interface is configured to:
display the SC current applied to the at least one battery and the internal temperature of the at least one battery; and
receive user input designating an instruction to turn the system for internal heating of the at least one battery or the control system on or off; an SC current to apply to the at least one battery; an amount of time to heat the at least one battery.

11. The system of claim 10, wherein the user input further designates an instruction to enable a manual mode or an automatic mode for activation and deactivation of the internal heating of the at least one battery; and an instruction to activate or deactivate the internal heating of the at least one battery when in the manual mode.

12. The system of claim 10, wherein the user interface comprises a user interface of a mobile application executed on a computing device communicatively coupled with the MCU.

13. A method for internal heating of at least one battery, comprising:
measuring, with at least one current sensor, a short circuit (SC) current applied to at least one battery;
measuring, with at least one temperature sensor, an internal temperature of the at least one battery;
monitoring, with an MCU, the SC current applied to the at least one battery and the internal temperature of the at least one battery;
activating, with the MCU, internal heating of the at least one battery when the internal temperature of the at least one battery is less than a temperature setpoint, wherein the SC current applied to the at least one battery is less than a SC current setpoint; and
generating, with the MCU, a pulse width modulation (PWM) signal to switch the at least one MOSFET switch on and off when the internal heating of the at least one battery is activated.

14. The method of claim 13, further comprising, iteratively:
activating, with the MCU, an on timer of an on/off timer when the internal heating of the at least one battery is activated;
executing, with the MCU, a variable PWM duty cycle loop until a time measured by the on timer reaches an on timer setpoint period, wherein the MCU increases or decreases a PWM duty cycle based on the SC current applied to the at least one battery;
terminating, with the MCU, the variable PWM duty cycle loop upon reaching the on timer setpoint period;
activating, with the MCU, an off timer of the on/off timer upon reaching the on timer setpoint period, wherein excess heat generated by the at least one MOSFET switch is transferred to the at least one battery; and
generating, with the MCU, the PWM signal to switch the at least one MOSFET switch on upon a time measured by the off timer reaching an off timer setpoint period.

15. The method of claim 14, wherein the MCU increases or decreases the PWM duty cycle by a percentage value when the SC current applied to the at least one battery has a C-rate greater or less than a C-rate setpoint or the SC current applied to the at least one battery is greater or less than the SC current setpoint.

16. The method of claim 15, wherein:
the percentage value is one percent; and
the percentage value is adjusted to a magnitude greater than the one percent when the SC current applied to the at least one battery reaches a threshold SC current.

17. The method of claim 13, wherein:
The temperature setpoint is 0 degrees Celsius; and
the SC current setpoint is 100 Amps.

18. The method of claim 13, further comprising:
autonomously learning, with the MCU or a mobile application executed on a computing device communicatively coupled with the MCU, an optimal C-rate and an optimal PWM frequency, within a range that is not damaging to the at least one battery and its lifespan, for different battery chemistries, battery state of charges, battery capacities, and ambient temperatures based on performance metrics using machine learning techniques wherein:
the performance metrics comprise at least a rate at which the internal temperature of the at least one battery rises.

19. The method of claim 13, further comprising:
determining, with the MCU or a mobile application executed on a computing device communicatively coupled with the MCU, a C-rate and a PWM frequency based on user input designating an amount of time to heat the at least one battery.

20. The method of claim 13, wherein a user interface of a mobile application executed on a computing device communicatively coupled with the MCU is configured to:
display the SC current applied to the at least one battery and the internal temperature of the at least one battery; and
receive user input designating at least one of: an instruction to turn the system for internal heating of the at least one battery or the control system on or off; an SC current to apply to the at least one battery; an amount of time to heat the at least one battery; an instruction to enable a manual mode or an automatic mode for activation and deactivation of the internal heating of the at least one battery; and an instruction to activate or deactivate the internal heating of the at least one battery when in the manual mode.
